(19) United States
(12) Patent Application Publication
(10) Pub. No.: US 2010/0006501 A1
(43) Pub. Date: Jan. 14, 2010

(54) METHOD FOR SEPARATION

(75) Inventors: Lars Thomas Laurell, Lund (SE); Filip Tobias Petersson, Stockholm (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: ERYSAVE AB, Lund (SE)

(21) Appl. No.: 12/299,191

(22) PCT Filed: May 4, 2007
(86) PCT No.: PCT/EP2007/054372

§ 371 Date: Oct. 31, 2008

(30) Foreign Application Priority Data
May 5, 2006 (SE) 0601017-7

(51) Int. Cl. B01D 15/38

(52) U.S. Cl. 210/635

(57) ABSTRACT

The invention relates to a method for separation of elements from a fluid using affinity-bearing particles suspended in the fluid and using ultrasonic standing waves and micro-fluidics. The method includes the steps of: mixing said fluid mixture with particles (10) having affinity to at least one element (9) to be separated; allowing the element (9) to be separated to bind to said affinity-bearing particles (10); subjecting the fluid to an ultrasonic wave field resulting in forces on the affinity-bearing particles (10) but substantially no forces on elements not bound to affinity-bearing particles; and allowing said forces to move said affinity-bearing particles (10) to a portion of the fluid thus obtaining a locally higher concentration of affinity-bearing particles. The method may be performed in a process with continuous flow.

### FIELD OF THE INVENTION

The present invention relates to a method for separation of elements or substances from a fluid using affinity-bearing particles suspended in the fluid and using ultrasonic standing waves and micro-fluidics.

### STATE OF THE ART

It is known that when particles in a fluid are subjected to an acoustic standing wave field, the particles are displaced to locations at, or in relation to the standing wave nodes and antinodes. A number of attempts to use ultrasound standing wave field for the manipulation or separation are known.

In WO 02/072235 is described a device and a method for separating particles from fluids using ultrasound, laminar flow, and stationary wave effects comprising a micro-technology channel system with an integrated branching point or branching fork, and a single ultrasound source. The single ultrasound source, which generates the standing waves, excites the complete structure including the channel system.

Also, magnetically activated cell sorting (MACS) methods are known. U.S. Pat. No. 5,876,925 discloses a system for magnetically activated cell sorting for production of proteins. The protein is capable of binding to an antigen-bearing moiety. A magnetic label is added to cells expressing the antigen-bearing moiety and the cells are incubated with a virus expressing the protein in the presence of an excess of unlabeled cells that do not express the antigen-bearing moiety to form a mixture, wherein the virus binds to the magnetically labeled cells. A separation is then performed in a magnetic field to isolate cells from the mixture having virus bound thereon. DNA encoding the protein is obtained from the virus to produce the protein. MACS is primarily adapted for batch-wise processes.

### SUMMARY OF THE INVENTION

An object of the invention is to provide a separation method relying on particles provided with an affinity-bearing surface. The affinity may be selected to capture a wide variety of substances or elements. The sorting is performed using ultrasound and based on the physical properties of the particles relative to a fluid in which the particles and elements are mixed and suspended. Physical properties such as density, size and compressibility may be used to distinguish the particles.

The present invention provides a method for separating an element from a mixture of elements suspended or dissolved in a first fluid including the steps of: mixing said fluid mixture with particles having affinity to at least one target element to be separated; allowing the element to be separated to bind to said affinity-bearing particles; subjecting the fluid to at least a first ultrasonic wave field resulting in forces on the affinity-bearing particles but substantially no forces on elements not bound to affinity-bearing particles; and

allowing said forces to move said affinity-bearing particles to a portion of the fluid thus obtaining a locally higher concentration of affinity-bearing particles with bound elements.

Preferably, the method further includes bringing the first fluid with a mix of elements and elements bound to affinity-bearing particles in fluid communication with a second fluid without causing mixing of the fluids; allowing said forces to move said affinity-bearing particles carrying said element to be separated from the first fluid to the second fluid, thereby depleting the first fluid and enriching the second fluid.

In embodiments of the invention, the fluid or fluids are brought to flow through a separation device arranged to subject the flows to the ultrasonic wave field.

The affinity-bearing particles may be of a plurality of kinds having different physical properties and affinities to different elements, such that the affinity-bearing particles are subjected to different forces resulting from the ultrasound wave field.

A number of outlets may be provided for discharge of separate flows containing different separated affinity-bearing particles. The separation method may be performed in a number of stages.

The invention is defined in the accompanying claim 1, while preferred embodiments are set forth in the dependent claims.

### BRIEF DESCRIPTION OF THE DRAWINGS

The invention will be described below with reference to the accompanying drawings, in which:

FIG. 1A is a schematic view of a broth with a mixed variety of elements;

FIG. 1B is a schematic view of affinity-bearing particles;

FIG. 1C is a schematic view of a broth with a mix of a variety of elements and affinity-bearing particles before binding;

FIG. 1D is a schematic view of a broth with the mix of FIG. 1C after binding of one kind of element;

FIG. 2 is a schematic view of a separation device according to an embodiment of the invention;

FIG. 3 is a schematic view of a separation process according to an embodiment of the invention;

FIG. 4 is a perspective view of a separation device according to an embodiment of the invention;

FIG. 5 is a top view of an inlet area of the separation device of FIG. 4;

FIG. 6 is a diagram of separated flows;

FIG. 7 is a top view of an outlet area of the separation device of FIG. 4;

FIGS. 8A, 8B, 8C and 8D are schematic views of standing wave patterns between two walls, and particle concentration in pressure nodes and antinodes, respectively;

FIG. 9B is a schematic top view of an inlet area of the separation device;

FIGS. 9A and 9C are cross section views taken along the lines 9A and 9C in FIG. 9B; and

FIG. 10 is a schematic view of a separation device according to another embodiment of the invention.

### DETAILED DESCRIPTION OF PREFERRED EMBODIMENTS

As is known from e.g. WO 02/72235 standing waves may be formed in fluid contained in a channel or vessel by imposing ultrasound. The standing waves have nodes and antinodes at defined positions. Particles suspended or dissolved in the fluid will experience forces in dependence of the physical properties relative to the fluid and in dependence of the distance to nodes and antinodes. Generally, particles having a lower density than the fluid will move to antinodes, while particles having higher density than the fluid will move to nodes. Also, larger particles will experience a larger force than small particles and will move with greater speed. Particles having different densities and compressibilities relative to each other will also move with different speeds.

The general equation expressing the acoustic radiation force on a particle in a standing wave may be written as:

$${F}_{r} = - ( \frac{π {P}_{0}^{2} {V}_{c} {β}_{w}}{2 λ} ) \cdot Φ ( β , ρ ) \cdot sin ( \frac{4 π z}{λ} )$$

$$with$$

$$Φ = ( 5 {ρ}_{c} - 2 {ρ}_{w} ) / ( 2 {ρ}_{c} + {ρ}_{w} ) - ( {β}_{c} / {β}_{w} ) , \\ where$$

Fᵣ=acoustic radiation force
P₀=applied acoustic pressure amplitude
V_{c}=particle volume
β_{w}=compressibility of the liquid
β_{c}=compressibility of the particle
λ=acoustic wave length
z=particle distance to the node
ρ_{c}=density of the particle
ρ_{w}=density of the liquid

### Reference: K. Yosioka, Y. Kawasima, Acustica 5 (1955) 167-173

The separation technique of the present invention exploits mainly two physical facts. Particles suspended in the fluid may be moved by means of ultrasound and particles may be provided with a surface having affinity to specific elements, i.e. they will form strong bonds to specific elements and thus capture and carry the elements with them. Generally, affinity-bearing particles (also referred to as affinity probe activated microbeads) are mixed with a fluid containing a variety of elements. One or some of the elements are to be removed from the fluid mixture, either to use the removed elements (enrichment mode) or to remove unwanted elements from the particle mixture (depletion mode). Imposing an ultrasonic standing wave pattern will impose forces moving the affinity-bearing particles from the mixture to another part of the fluid or, preferably, to a second fluid. The non-captured elements are also located in the ultrasonic wave field but they will not be significantly moved by the ultrasonic forces. This is due to either that the elements are much smaller than the affinity-bearing particles or that the elements have a density and compressibility close to the fluid's properties. Thus the elements will experience a very small acceleration compared to the affinity-bearing particles.

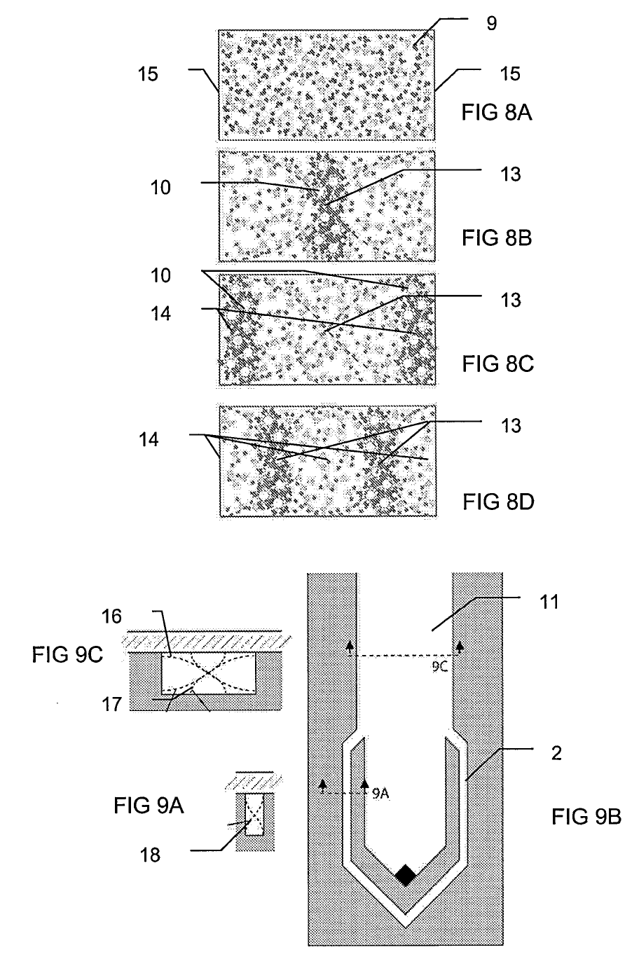

Numerous configurations of the vessel and channel are possible. In FIGS. 8A, 8B, 8C and 8D a cross-section transverse to a vessel or the flow direction of a channel is shown. The channel has vertical walls 15 between which a standing wave pattern is formed. Generally, all channel or vessel widths which are multiples of λ/2 are possible.

FIG. 8A shows a fluid mixture which is a liquid fluid containing a mixture of suspended or dissolved particles, in this application referred to as elements 9, of different kinds. In FIG. 8A the different elements are illustrated with different shapes and shades. The elements may be distinguished and separated by means of interaction with reagents. Particularly, elements will bind to reagents having a specific affinity to the element in question.

In FIG. 8B the fluid mixture has been mixed with affinity-bearing particles 10 which have captured one type of element. FIG. 8B shows a typical situation with one pressure node 13 located between the walls 15, i.e. the width is equal to λ/2. The affinity-bearing particles have higher density than the fluid and are moved to the node.

In FIG. 8C there is also one pressure node 13 located between the walls 15. In this case, however, the affinity-bearing particles have lower density than the fluid and are moved to the antinodes located at the walls 15.

In FIG. 8D the next resonance frequency (the width is equal to %) shows two nodes 13 and one antinode 14. The affinity-bearing particles have higher density than the fluid and are moved to the two nodes.

Also, the density of the carrier fluid can be tuned to a density level such that two affinity-bearing particles can be separated in the acoustic standing wave. The affinity-bearing particles with the relatively lower density are moved to the antinodes, while at the same time the affinity-bearing particles with the relatively higher density are moved to the nodes.

It will be appreciated that the height of the channel may be larger than its width. Then, the nodes will form a sheet parallel to the walls of the channel. The term vertical is used only for reference in the drawings, since the force of gravity on the suspended or dissolved particles is negligible. Thus, the channel may be oriented in any direction relative to the force of gravity.

The dimensions of the separation channel or vessel (and the corresponding ultrasound frequency) are selected such that laminar flow conditions persist. Thus, a minimum of mixing of different parts of the fluid flowing through the channel occurs and fluid together with particles carried by the fluid will flow in a straight direction, unless deflected by the shape of the channel system or exposed to inlet or outlet flows. However, the forces caused by the ultrasound standing waves will move particles between different laminas of the fluid. A channel is preferably rectangular in cross-section and the separation part of the channel commonly has a width of 700 μm or smaller for a one-node standing wave ultrasound field. Greater widths will be appropriate for standing wave ultrasound fields with more nodes. The ultrasound standing waves are produced by one or several acoustic generators.

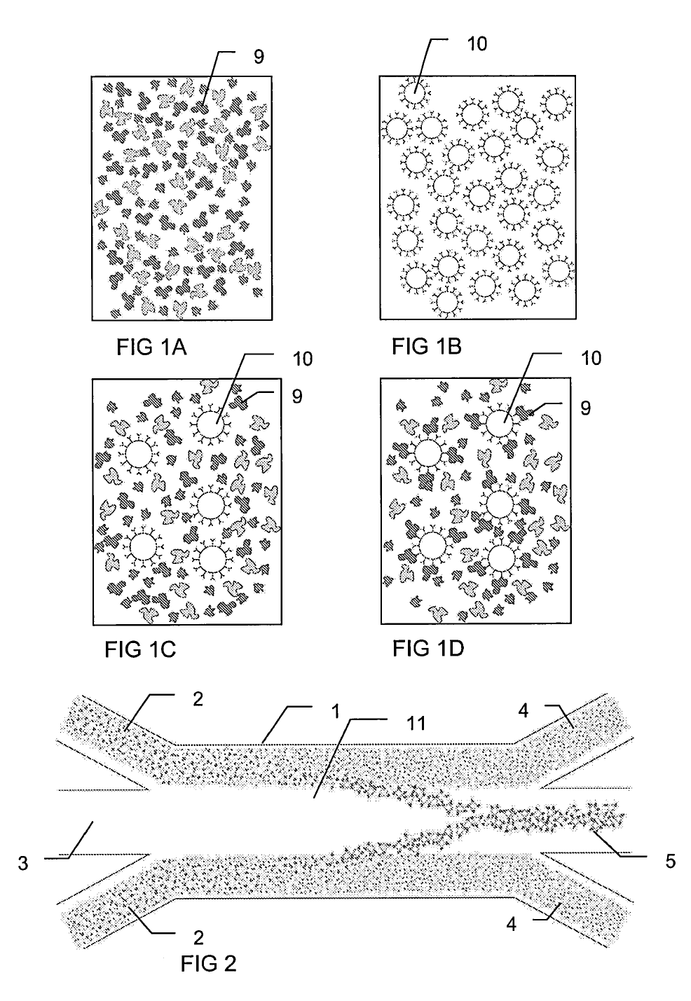

FIG. 1A shows a broth or fluid mixture with elements 9 of different kinds.

According to embodiments of the present invention, at least one kind of reagent is attached to particles which are influenced by forces caused by ultrasonic standing waves. FIG. 1B shows schematically particles 10 as circles with a special surface. The particles 10 may for example be polymethylmethacrylate beads and polystyrene beads. A wide variety of reagents are known in the art to provide the affinity to the particles. These may e.g. be based on antibodies, antibody fragments, lectins, metal chelating agents, ionic interaction, hydrophobic/hydrophilic interaction, DNA or RNA specific interaction, receptor interaction, enzyme interactions or protein/protein interactions.

In the first step the broth containing the particle mixture is mixed together with the affinity-bearing particles as is shown in FIG. 1C.

A sufficient time is allowed to lapse such that bonds between specific elements are formed between particles 10 and at least one specific element 9 as is shown in FIG. 1D.

Subsequently, a standing wave pattern generated by means of ultrasound is applied to the fluid mixture. In the simplest embodiment of the invention, ultrasound is applied on a vessel carrying a mixture. As shown in FIGS. 8B, 8C and 8D the affinity-bearing particles 10 may be moved to nodes or antinodes of the wave pattern resulting in a concentration gradient with a locally higher concentration at the nodes or antinodes. The particles may then be removed from the nodes or antinodes for further processing (or depleted fluid from the antinodes or nodes, respectively).

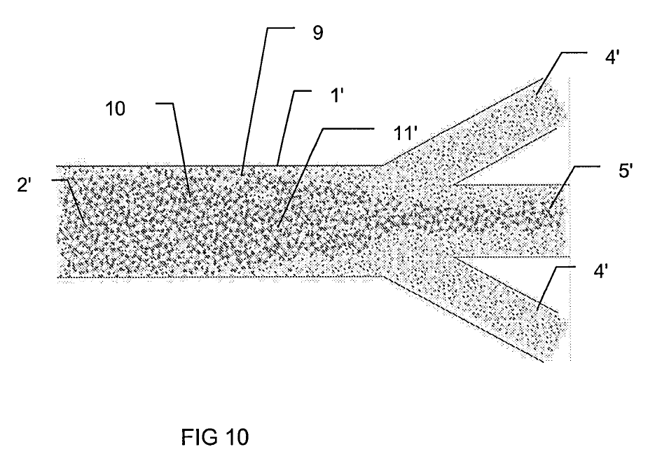

Also, the separation process may be arranged with a continuous flow. FIG. 10 shows a separation device 1′ for a single fluid. The separation device 1′ is provided with one inlet 2′, two side outlets 4′ and one central outlet 5′. A broth with a particle mixture with various elements 9 and affinity-bearing particles 10 with some elements bound thereto enters through the inlet 2′. It will be appreciated that the mixing and binding steps may be performed external of separation device 1′. An ultrasound standing wave pattern is formed in the main channel 11′ such that affinity-bearing particles are influenced by forces moving them to the central laminar flow as shown. Fluid depleted from affinity-bearing particles with elements bound thereto exits through the two side outlets 4′. Fluid enriched with affinity-bearing particles with elements bound thereto exits through the central outlet 5′.

In an alternative embodiment, only two outlets are provided. The enriched and depleted flows are instead separated by arranging suitable widths of the outlets and/or by controlling the exit flows at the respective outlets, e.g. by suction or adjustable restrictors.

Persons skilled in the art will appreciate the many arrangements are possible by selecting the acoustic wavelength relative to the channel or vessel width, selecting differentiated flow velocities or flow deflectors, selecting the number of outlets and inlets et cetera.

To improve the concentration gradient a second fluid, suitably a pure fluid of the same composition or a specially adapted fluid, may be arranged at the nodes (or antinodes) to which the affinity-bearing particles are moved. Preferably, the separation process is arranged with a continuous flow.

FIG. 2 shows schematically a separation process according to an embodiment of the invention with continuous flow of two fluids. A separation device 1 is provided with two side inlets 2 and a central inlet 3. A broth with a particle mixture with various elements and affinity-bearing particles with some elements bound thereto enters through the side inlets 2. Pure fluid is entering the central inlet 3. An ultrasound standing wave pattern is formed in the main channel 11 such that affinity-bearing particles are influenced by forces moving them from laminar side flows to the central laminar flow as shown. Fluid exits through two side outlets 4 and one central outlet 5. A particle mixture from which one or more element has been removed together with the affinity-bearing particles will exit mainly through the side outlets 4, while fluid now carrying affinity-bearing particles with bound elements will exit mainly through the central outlet 5.

With another selection of density relative to the fluid the affinity-bearing particles can be moved from a central flow to side flows where antinodes are located. In this case pure fluid will enter through the side inlets and the particle mixture will enter through the central inlet. The affinity-bearing particles will then be moved to the side flows carrying with them elements to be separated.

Similarly to the embodiment with a single fluid, the separation device may be provided with only two outlets. The enriched and depleted flows are instead separated by arranging suitable widths and/or by controlling the exit flows by differentiated suction velocities (flow rates) at the respective outlets. However, a separate inlet is required for the pure fluid. This may be arranged at one side of the channel.

It will be appreciated that some mixing or leakage between the two fluids is unavoidable due to dispersion and other factors. For this reason, it may be desired to direct e.g. only a part of enriched fluid to one outlet, while depleted fluid and the other part of the enriched fluid is directed to other outlets. In this way, contamination of the enriched fluid with depleted fluid may be avoided.

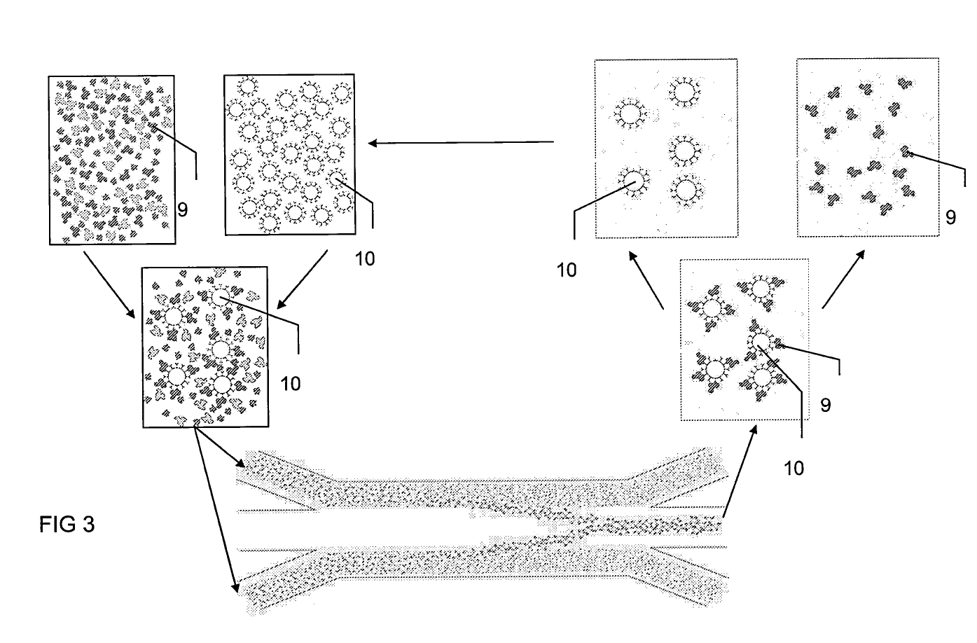

FIG. 3 shows the same process as FIG. 2 and illustrates how affinity-bearing particles are recycled in one embodiment of the invention. After the separation through the separation device 1, particles 10 with bound elements 9 are treated to release the bonds. Various release agents are known in the art. Thus, the elements 9 may be collected for further processing while the affinity-bearing particles 10 may be brought back into the process.

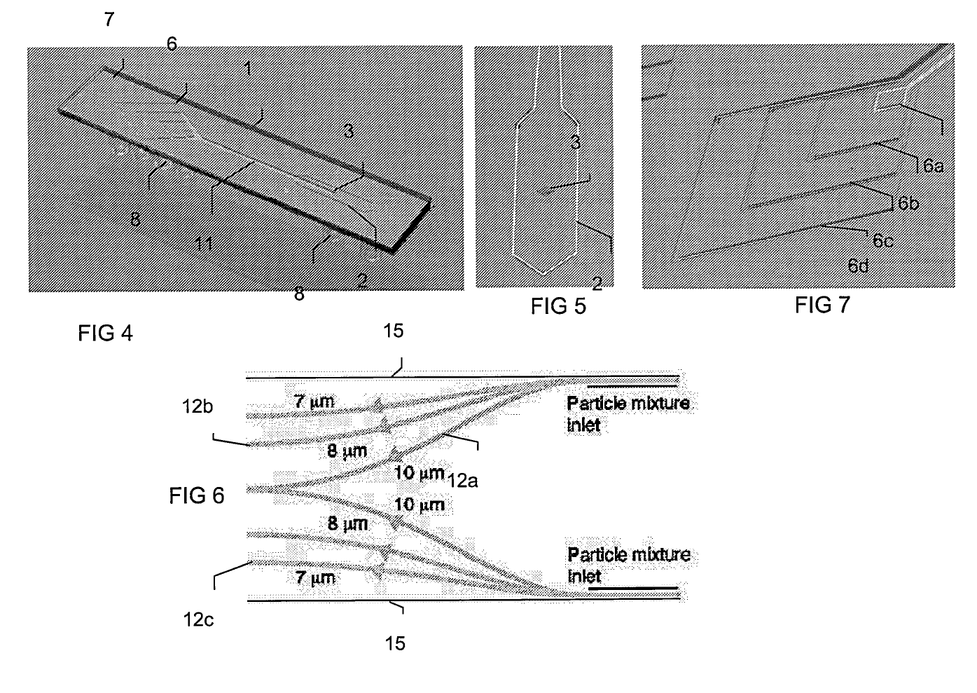

An embodiment of the separation device 1 is shown in FIG. 4. Channels may for instance be formed in a silicon chip 7 using known procedures. The device is provided with side inlets 2, a central inlet 3 and a number of outlet channels generally denoted by reference numeral 6 (a close-up is seen in FIG. 7). Connections 8 are provided on the underside to the respective inlets and outlets.

As shown in FIG. 5, the central inlet 3 supplies fluid to almost the whole width of the channel while the side inlets 2 introduce fluid close to the sides only.

As mentioned previously, the forces imposed on the particles depend on size, density, and compressibility. For instance, particles having sizes of 10 μm, 8 μm, and 7 μm may be used, each with an affinity to a specified element.

As shown in FIG. 6, the particles with the largest size, 10 μm, will travel the fastest towards the centre of the main channel along trajectories illustrated by lines 12a. The particle size 8 μm, will form a pair of bands 12b between the walls and centre, and the particle size 7 μm, will form a pair of bands 12c even closer to the side walls 15. The length of the ultrasound field, the flow velocity and the intensity of the ultrasound are selected such that separation is achieved. In principle all particle sizes tend to travel to the centre of the channel as long as the ultrasound is imposed.

A similar type of separation may be performed on a mixture of different kinds of elements having different physical properties, such that the different kinds of elements are subjected to different forces resulting from the ultrasound wave field.

At the outlet side four outlets are provided. The central outlet 6a collects the central portion of the width of the channel. Suitably, the channel ends in a flow dividing fork even for the centre channels 6a. Outside the centre channels are successive channels 6b and 6c, each collecting a pair of bands of the flow, while the side channel 6d collects the flows closest to the walls of the channel 11. Due to the laminar flow in the system the separate bands will substantially not mix, but each particle size can be collected mainly at its respective outlet.

In an alternative embodiment, only one particle size is separated at a time, for example the largest at the centre, while the other, smaller particle sizes are collected together and subjected to a further separation in a separate stage.

In the course of traversing the flow channel along the ideal trajectories (12a-c) as outlined in FIG. 6 the band of particles will broaden (disperse) as they follow the flow at different depths of the channel, thus experiencing different flow velocities due to the parabolic flow profile in the laminar flow, and consequently experience the employed acoustic force for different lengths of time.

The performance may be improved by inducing a second acoustic standing wave between the top and bottom of the flow channel, as is shown in FIGS. 9A, 9B, and 9C. FIG. 9C shows a second acoustic standing wave 17 substantially perpendicular to the main or first acoustic standing wave 16 in the channel 11. In this way, particles can be forced to the centre of the flow channel 11 in two dimensions and thus the above described dispersion can be minimised. The second acoustic standing wave can be generated by the same source that generates the main acoustic standing wave between the side walls, now excited at two frequencies corresponding to the resonance criterion in each direction.

Alternatively the vertical acoustic focusing can be performed by a second acoustic generator that focuses the particles vertically as shown at 18 in the channel 11 and/or already in the side inlet channel as shown in FIG. 9A with a second acoustic standing wave 18, prior to entering the channel 11 where the particles are separated or focused sideways as outlined in FIG. 6.

The arrangement with a second acoustic standing wave perpendicular to the main or first acoustic standing wave may be exploited generally in systems with separation using acoustic standing waves in order to minimise dispersion.

A number of separation devices 1 may be connected, such that the separation process is repeated in stages. Between the stages, different affinity-bearing particles may be added to the fluid mixture for obtaining customised specific separations.

A number of parallel separation devices may be realised in the same body to offer an increased systemic throughput.

Laminar flow systems may be designed in many ways and the embodiment shown is only an example. Further examples with regard to various separation processes are set forth below.

### Affinity Based Enrichment

An example of the use of an affinity probe activated microbead (affinity-bearing particle) in the separation process according to the invention is affinity based enrichment where a rarely occurring cell or particle (element) is enriched and collected at a given location in the flow stream, defined by the acoustophysical properties of the carrier bead used. An example of this is the selection and enrichment of stem cells from bone marrow. Alternatively the selection can be made directly from blood. By activating microbeads with antibodies directed against stem cell markers these will bind to the stem cells when mixed with the bone marrow suspension or blood. The microbead affinity probed stem cells can then be extracted from its complex biofluid as it is passed through the acoustic separation device operated in a suitable mode as described in the application. It is thus possible to selectively extract stem cells from a bone marrow suspension in a continuous flow mode.

### Affinity Based Depletion

Another mode of operation is so called depletion mode where a sample is processed by means of the separation process according to the invention such that a targeted species is removed from the main population of particles or cells.

In bone marrow transplants to leukemia patients there is an expressed need for reducing/depleting the B- and T-cells as these may induce a graft versus host reaction, resulting in a failure in the transplant therapy. The separation process according to the invention offers a possibility to remove B- and T-lymphocytes from the bone marrow donation prior to the transplantation process.

The affinity based depletion mode can also be used in applications where not only cellular or particular matter needs to be removed from the fluid but the target is at a molecular level. An example of this is in the processing of blood to remove high levels of inflammatory components or in acute treatment of sepsis where the release of a cascade of hazardous components in the blood has to be removed instantly. By employing the separation process according to the invention, using microbeads activated with antibodies targeting the molecular species of interest blood may be washed. In this way an on-line sepsis treatment may be accomplished.

It will be appreciated by persons skilled in the art that the separation process according to the invention may be used in numerous applications involving reagents with specific affinity, bio-specific, cellular, molecular or other, to any element that is to be separated from a fluid mixture. The scope of the invention is defined by the claims below.

1. A method for separating an element from a mixture of elements suspended or dissolved in a first fluid including the steps of:
mixing said fluid mixture with particles having affinity to at least one target element to be separated;
allowing the element to be separated to bind to said affinity-bearing particles;
subjecting the fluid to at least a first ultrasonic wave field resulting in forces on the affinity-bearing particles but substantially no forces on elements not bound to affinity-bearing particles; and
allowing said forces to move said affinity-bearing particles to a portion of the fluid thus obtaining a locally higher concentration of affinity-bearing particles bound to its target element.

2. A method according to claim 1, further
collecting said portion of the fluid with a higher concentration of affinity-bearing particles for further use.

3. A method according to claim 1, further
collecting a portion of the fluid with a lower concentration of affinity-bearing particles for further use.

4. A method according to claim 1, further bringing the fluid to flow through a separation device arranged to subject the flow to the ultrasonic wave field; wherein said portion of the fluid with a higher concentration of affinity-bearing particles is discharged mainly through a separate outlet.

5. A method according to claim 4, portions of the fluid are collected at a plurality of outlets.

6. A method according to claim 1, further bringing the first fluid with a mix of elements and elements bound to affmity- bearing particles in fluid communication with a second fluid at a minimum of mixing of the fluids; allowing said forces to move said affinity-bearing particles carrying said element to be separated from the first fluid to the second fluid, thereby depleting the first fluid and enriching the second fluid.

7. A method according to claim 6, wherein the first fluid that has been depleted is collected for further use.

8. A method according to claim 6, wherein the second fluid that has been enriched is collected for further use.

9. A method according to claim 2, wherein the element to be separated is released from the affinity-bearing particles during said further use.

10. A method according to claim 9, wherein the affinity-bearing particles are reused in a further separation process.

11. A method according to claim 6, wherein the first fluid and second fluid are brought to flow through a separation device arranged to subject the flows to the ultrasonic wave field.

12. A method according to claim 11, wherein the first fluid is brought to flow at sides of a channel, and the second fluid is brought to flow at the centre of said channel, and the first fluid is collected mainly at side outlets, while the second fluid is collected mainly at at least one central outlet.

13. A method according to claim 11, wherein the second fluid is brought to flow at sides of a channel, and the first fluid is brought to flow at the centre of said channel, and the second fluid is collected mainly at side outlets, while the first fluid is collected mainly at at least one central outlet.

14. A method according to claim 5, wherein the respective fluids are collected at a plurality of outlets.

15. A method according to claim 1, wherein the affinity-bearing particles are of a plurality of kinds having different physical properties and affinities to different elements, such that the affinity-bearing particles are subjected to different forces resulting from the ultrasound wave field.

16. A method according to claim 15, wherein the affinity-bearing particles are of different density, or different size, or different compressibility.

17. A method according to claim 1, wherein the affinity-bearing particles are of a plurality of kinds having different physical properties
and affinities to different elements, and the density of the first fluid is tuned to a density level such that at least two affinity-bearing particles are subjected to differently directed forces resulting from the ultrasound wave field.

18. A method according to claim 1, wherein the fluid is subjected to a further ultrasonic wave field resulting in forces concentrating the affinity-bearing particles in a direction substantially perpendicular to the first ultrasonic wave field.

19. A method according to claim 17, wherein a first fluid is brought to flow at sides of a channel, and a second fluid is brought to flow at the centre of said channel, and the further ultrasonic wave field is applied in said channel.

20. A method according to claim 17, wherein the first fluid is brought to flow at sides of a channel through side inlets, and the second fluid is brought to flow at the centre of said channel, and the further ultrasound wave field is applied in said side inlets.

21. A method according to claim 1, wherein the affinity is based on antibodies, antibody fragments, lectins, metal chelating agents, ionic interaction, hydrophobic/hydrophilic interaction, DNA or RNA specific interaction, receptor interaction, enzyme interactions or protein/protein interactions.

22. A method according to claim 1, wherein the separation is repeated in a number of stages.

23. A method according to claim 21, wherein affinity-bearing particles with different physical properties and different affinities are used in different stages.

24. A method according to claim 1, wherein the separation is performed in a number of parallel steps.

25. A method for separating an element from a mixture of elements suspended or dissolved in a fluid including the steps of:
subjecting the fluid to at least a first ultrasonic wave field resulting in forces on the elements; and
allowing said forces to move said elements to a portion of the fluid thus obtaining a locally higher concentration of the elements, wherein the fluid is subjected to a further ultrasonic wave field resulting in forces concentrating the elements
in a direction substantially perpendicular to the first ultrasonic wave field.

26. A method for separating an element from a mixture of different kinds of elements suspended or dissolved in a fluid including the steps of: subjecting the fluid to at least a first ultrasonic wave field resulting in forces on the elements; and
allowing said forces to move said elements to portions of the fluid thus obtaining locally higher concentrations of the elements, wherein the different kinds of elements are of a plurality of kinds having different physical properties, such that the different kinds of elements are subjected to different forces resulting from the ultrasound wave field.

27. A method according to claim 26, wherein the different kinds of elements have different physical properties, and the density of the fluid is tuned to a density level such that at least two different kinds of elements are subjected to differently directed forces resulting from the ultrasound wave field.

28. A method for separating an element from a mixture of different kinds of elements suspended or dissolved in a fluid including the steps of: subjecting the fluid to at least a first ultrasonic wave field resulting in forces on the elements; and
allowing said forces to move said elements to portions of the fluid thus obtaining locally higher concentrations of the elements, wherein the different kinds of elements are of a plurality of kinds having different physical properties, such that the different kinds of elements are subjected to different forces resulting from the ultrasound wave field, and wherein the fluid is subjected to a further ultrasonic wave field resulting in forces concentrating the first kind of elements in a direction substantially perpendicular to the first ultrasonic wave field.
